(19) United States
(12) Patent Application Publication
(10) Pub. No.: US 2011/0088853 A1
(43) Pub. Date: Apr. 21, 2011

(54) ACCESSORIZABLE VENTILATION SCREEN SYSTEMS FOR VEHICLES

(76) Inventor: Lorenzo Boston, San Francisco, CA (US)

(21) Appl. No.: 12/898,731

(22) Filed: Oct. 6, 2010

Related U.S. Application Data
(60) Provisional application No. 61/252,789, filed on Oct. 19, 2009.

(51) Int. Cl. B60J 1/20

(52) U.S. Cl. 160/87; 160/127

(57) ABSTRACT

A secure ventilation screen which may be used in a variety of makes and models of vehicles to provide adequate ventilation and air circulation inside the vehicle while keeping vehicle occupants safe as well as preventing bugs and outside debris from entering a vehicle. The secure ventilation screen system comprises a rigid mesh material to provide ventilation and is secured by a flexible and durable frame which may be installed into the frame of a vehicle window. The secure ventilation screen system may be manufactured in different sizes and may be installed into substantially any vehicle window. A secure ventilation screen system kit may comprise an accessorizable ventilation screen for vehicle windows and accessories such as a temperature gauge, key alarm, hold unit, sound alarm, and air conditioning component.

### CROSS-REFERENCE TO RELATED APPLICATION

The present application is related to and claims priority from prior provisional application Ser. No. 61/252,789, filed Oct. 19, 2009 which application is incorporated herein by reference.

### BACKGROUND OF THE INVENTION

1. Field of the Invention

The present invention relates generally to the field of ventilation screens and more specifically relates to an accessorizable ventilation screen for vehicle windows.

2. Description of the Related Art

Many individuals own and use vehicles in the modern era to accomplish a variety of essential tasks. During travel times in vehicles, many vehicle drivers and passengers prefer to leave their vehicle windows down to allow for adequate air circulation. However, many drivers and passengers are wary to leave their vehicle windows down for extended periods due to bugs and other debris that may easily enter into the vehicle via an open window. Vehicle owners may also worry that papers or other items may fly out of an open window. Furthermore, it may be unsafe to leave the windows down when the vehicle is parked because someone could easily reach through the open window and steal items or cause vehicle damage when left unattended. Therefore, a device is needed that allows users to comfortably and securely keep their windows down.

Various attempts have been made to solve the above-mentioned problems such as those found in U.S. Pat. Nos. 4,285,383, 6,367,536, 5,524,694, 5,290,086, 5,443,110, 2,710,058, and 4,653,562. This prior art is representative of screens for use with vehicles. None of the above inventions and patents, taken either singly or in combination, is seen to describe the invention as claimed.

Ideally, an accessorizable ventilation screen for vehicles should require minimal maintenance and, yet, would operate reliably to provide suitable security and be manufactured at a modest expense. Thus, a need exists for a reliable ventilation screen system to easily install into a vehicle window allowing users to comfortably and securely keep their windows down while providing ventilation and air circulation for inside the vehicle and to avoid the above-mentioned problems.

### BRIEF SUMMARY OF THE INVENTION

In view of the foregoing disadvantages inherent in the known ventilation screen for use with vehicles art, the present invention provides a novel accessorizable ventilation screen for vehicles system. The general purpose of the present invention, which will be described subsequently in greater detail is to provide an accessorizable ventilation screen for vehicles to promote comfort and security for its users.

Disclosed herein is an accessorizable ventilation screen system for use with a vehicle comprising: at least one removable ventilation screen; and at least one accessory holder; wherein the accessory holder is securably attached into the removable ventilation screen creating an accessorizable ventilated window assembly and the accessorizable ventilated window assembly is removably insertable into a vehicle opening. The removable ventilation screen is preferably flexible and may comprise corrosion-resistant material. In certain embodiments the removable ventilation screen comprises filter-apertures to inhibit outside debris and bugs from entering the vehicle while providing ventilation for occupants of the vehicle. The removable ventilation screen also preferably comprises a flexible frame unit which comprise at least one insertion tab and at least one window buffer. The accessory holder comprises levering means to open and close the accessory holder that may comprise containment means.

In certain embodiments the device may comprise key alarm means, a temperature gauge accessory, air conditioning accessory, at least sound alarm accessory, a hold unit. Also disclosed is a kit for manufacture and sale for the mentioned system. The accessorizable ventilated window assemblies are manufacturable in a variety of sizes to fit in different size vehicle window openings. The vehicle openings that the present invention may be used in may comprise a window, door, and/or sun-roof.

The present invention holds significant improvements and serves as an accessorizable ventilation screen for vehicles system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, accessorizable ventilation screen for vehicles, constructed and operative according to the teachings of the present invention.

FIG. 1 shows a perspective view illustrating an accessorizable ventilation screen for vehicles installed in a vehicle window according to an embodiment of the present invention.

FIG. 2 is a perspective view illustrating the accessorizable ventilation screen and installation tabs according to an embodiment of the present invention of FIG. 1.

FIG. 3 illustrates the accessorizable ventilation screen for vehicles and accompanying accessories according to an embodiment of the present invention of FIG. 1.

FIG. 4 is a flowchart illustrating a method of use according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to an accessorizable ventilation screen and more particularly to an accessorizable ventilation screen as used to improve the ventilation and air circulation inside vehicle while preventing bugs and debris from entering vehicle.

Accessorizable ventilation screen system 100 comprises a device user 110 may install in vehicle window area 115 which may substantially prevent bugs and other outside debris from entering vehicle 140 while providing air circulation for motorists 125 and passengers 130 inside vehicle 140. Accessorizable ventilation screen system 100 may comprise flexible frame unit 120 with accessorizable ventilation screen 104 wherein accessorizable ventilation screen 104 may be securably inserted inside flexible frame unit 120. User 110 may then install accessorizable ventilation screen system 100 into vehicle window area 115 when vehicle window 145 is in a full-retracted position. Flexible frame unit 120 of accessorizable ventilation screen 104 may be removably inserted into vehicle window area 115 via insertion tabs 210 positioned along frame unit periphery 200. Accessorizable ventilation screen system 100 is designed so that user 110 may snappably insert and remove accessorizable ventilation screen 104 securely into vehicle window area 115 with ease and convenience.

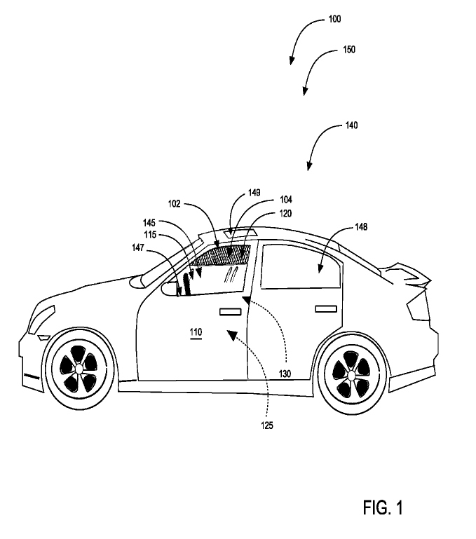

Referring to the drawings by numerals of reference there is shown in FIG. 1 accessorizable ventilation screen system 100 in use according to a preferred embodiment of the present invention. Accessorizable ventilation screen 104 as shown is installed in rear side window 104 of car 160. Accessorizable ventilation screen 104 may be installed in vehicle window area 115 including, but not limited to, front side windows 147, rear side windows 148, and/or sun roof 149.

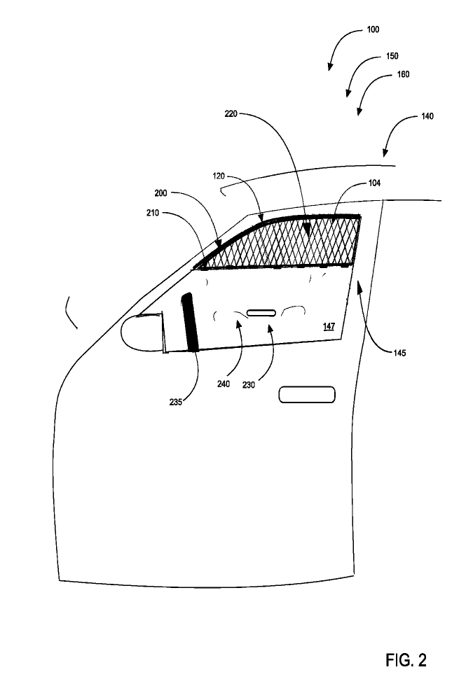

Referring now to FIG. 2, accessorizable ventilation screen system 100 preferably comprises a sturdy mesh accessorizable ventilation screen 104 with a plurality of filter-apertures 220 permitting air to pass through while substantially filtering out debris and bugs. Accessorizable ventilation screen 104 may be manufactured of a corrosion resistant material so that the ventilation screen mesh may withstand rain, snow, and other such precipitation. Flexible frame unit 120 may be manufactured of plastic, galvanized steel, or other suitable material. As seen in FIG. 2, flexible frame unit 120 preferably comprises insertion tabs 210 located along frame unit periphery 200 of flexible frame unit 120. In use, insertion tabs 210 may be securely fastened to vehicle window area 115 so that accessorizable ventilation screen 104 may be frictionally mounted securely in place while vehicle 140 is in motion.

In a preferred embodiment of the present invention, accessorizable ventilation screen for vehicles 104 may comprise accessory holder 230 as best seen in FIG. 2. Accessory holder 230 may be located on a surface of accessorizable ventilation screen 104 and may comprise compartment space 240 with adequate room to store various accessories. Accessory holder 230 may further comprise lever 235 which may open and close accessory holder 230. Lever 235 may be manufactured of suitably durable materials so as to permit user to open and close accessory holder 230 while not protracting too far from accessorizable ventilation screen 104 (located in close spatial proximity) so as to prevent injury.

In alternative embodiments of the present invention, accessorizable ventilation screen 104 and flexible frame unit 120 may be manufactured in various dimensions as to fit a conventional vehicle window area 115. Vehicles may range from cars 160, SUV's 161, trucks 162, buses 163, limousines 164, and other suitable modes of transportation. Further, accessorizable ventilation screen 104 may be custom designed by consumer preference so as to fit different makes and models of various vehicle 140 types.

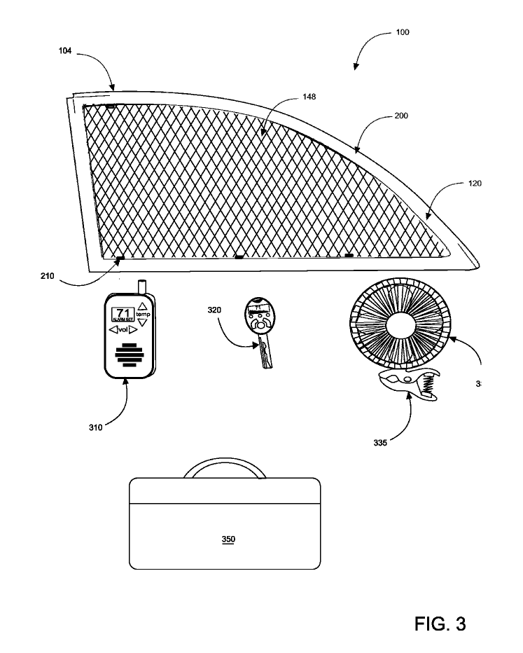

Referring now to FIG. 3, where the various accessories of accessorizable ventilation screen system 100 and accessorizable ventilation screen 104 and flexible frame unit 120 are shown for enablement of the present invention. Preferably, accessorizable ventilation screen system 100 is sold in pairs of matching shapes (mirror-image) suitable for vehicle window area 115 of equal dimensions but located on opposite sides. The complete accessorizable ventilation screen system 100 may be sold with an accompanying carrying case 350 to protect and store accessorizable ventilation screen 104 and accessories during non-use. Carrying case 350 may have different compartments to store the various components of accessorizable ventilation screen system 100.

In one embodiment of the present invention, temperature gauge sound alarm 310 accessory is provided. Temperature gauge sound alarm 310 may comprise a small electronic device that will digitally read the current temperature. In an alternative embodiment, remote key alarm 320 accessory is provided. Remote key alarm 320 accessory may also comprise a temperature gauge and digital reader and different buttons on remote key alarm 320 may operate functions of vehicle 140 such as door locking and unlocking, alarm activation, trunk opening, and the like. In other embodiments, accessorizable ventilation screen system 100 may comprise air conditioning accessory 330. Air conditioning accessory 300 may be in the form of a miniature portable fan or other battery-powered cooling means. The air conditioning accessory may comprise clip fastener 335 for attachment purposes within vehicle 140 for additional air circulation.

An accessorizable ventilation screen system kit 390 for vertical attachment in vehicle 140 comprising: at least one first set of accessorizable ventilated window assemblies 102 for placement in front side windows 147 of vehicle 140; and at least one second set of accessorizable ventilated window assemblies 102 for placement in rear side window(s) 148 of vehicle 140; wherein first and second sets of accessorizable ventilated window assemblies 102 inhibit debris and bugs from entering vehicle 140 while providing ventilation for occupants of vehicle 140.

Kit 390 may further comprise accessory holder 230, key alarm means (hereby embodying remote key alarm 320), temperature gauge accessory (hereby embodying temperature gauge sound alarm 310), air conditioning accessory 330, sound alarm accessory, and a hold unit. The accessorizable ventilated window assemblies 102 are manufacturable in a variety of sizes to fit in different size openings of vehicle window 145 (front side windows 147 and rear side windows 148).

Motorists 125 and passengers 130 of vehicle 140 will appreciate the various advantages of accessorizable ventilation screen system 100. The sturdy, non-corrosive mesh accessorizable ventilation screen 104 may serve to provide ventilation and air circulation for occupants inside vehicle 140 while substantially filtering out unwanted bugs and debris from penetrating accessorizable ventilation screen 104. Furthermore, accessorizable ventilation screen 104 may provide security for the occupants of vehicle 140. Accessorizable ventilation screen system 100 may be custom designed in various dimensions and appearances to suit a variety of consumer taste and preferences.

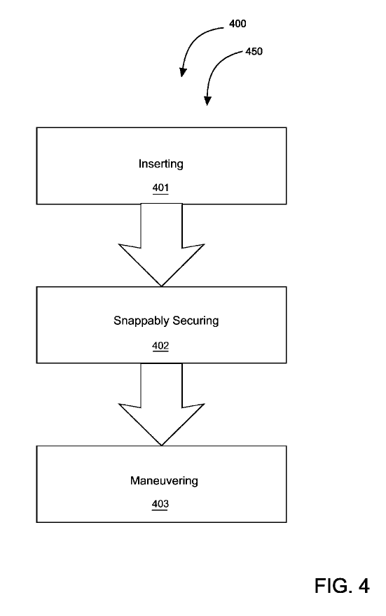

Referring now to FIG. 4, showing a flowchart 450 illustrating a preferred method of use 400 according to an embodiment of the present invention of FIGS. 1-4.

In accordance with the embodiments of the present invention a preferred method of use 400 is disclosed herein comprising: step one 401 inserting accessorizable ventilation screen 104 into vehicle window area 115; step two 402 snappably securing insertion tabs 210 located on frame unit periphery 200 of flexible frame unit 120 to a retracted vehicle window 145; and step three 403 maneuvering accessory holder 230 via lever 235.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An accessorizable ventilation screen system for use with a vehicle comprising:
at least one removable ventilation screen; and
at least one accessory holder;
wherein said accessory holder is securably attached into said removable ventilation screen creating an accessorizable ventilated window assembly and said accessorizable ventilated window assembly is removably insertable into a vehicle opening.

2. The accessorizable ventilation screen system of claim 1 wherein said removable ventilation screen is flexible.

3. The accessorizable ventilation screen system of claim 1 wherein said removable ventilation screen comprises corrosion-resistant material.

4. The accessorizable ventilation screen system of claim 1 wherein said removable ventilation screen comprises filter-apertures.

5. The accessorizable ventilation screen system of claim 4 wherein said filter-apertures inhibit outside debris and bugs from entering the vehicle while providing ventilation for occupants of said vehicle.

6. The accessorizable ventilation screen system of claim 1 wherein said removable ventilation screen comprises a flexible frame unit.

7. The accessorizable ventilation screen system of claim 6 wherein said flexible frame unit comprises at least one insertion tab.

8. The accessorizable ventilation screen system of claim 6 wherein said flexible frame unit comprises at least one window buffer.

9. The accessorizable ventilation screen system of claim 1 wherein said accessory holder comprises levering means to open and close said accessory holder.

10. The accessorizable ventilation screen system of claim 9 wherein said accessory holder comprises containment means.

11. The accessorizable ventilation screen system of claim 1 further comprises key alarm means.

12. The accessorizable ventilation screen system of claim 1 further comprises a temperature gauge accessory.

13. The accessorizable ventilation screen system of claim 1 further comprises air conditioning accessory.

14. The accessorizable ventilation screen system of claim 1 further comprises sound alarm accessory.

15. The accessorizable ventilation screen system of claim 1 further comprises a hold unit.

16. An accessorizable ventilation screen system kit for vertical attachment in a vehicle comprising:
at least one first set of accessorizable ventilated window assemblies for placement in side windows of said vehicle; and
at least one second set of accessorizable ventilated window assemblies for placement in rear windows of said vehicle;
wherein said first and said second sets of accessorizable ventilated window assemblies inhibit debris and bugs from entering the vehicle while providing ventilation for occupants of said vehicle.

17. The accessorizable ventilation screen system kit of claim 16 further comprises an accessory holder, key alarm means, temperature gauge accessory, air conditioning accessory, sound alarm accessory, and a hold unit.

18. The accessorizable ventilation screen system kit of claim 16 wherein said accessorizable ventilated window assemblies are manufacturable in a variety of sizes to fit in different size vehicle window openings.

19. An accessorizable ventilation screen system for use with a vehicle comprising:
at least one removable ventilation screen comprising a corrosion-resistant material with filter-apertures housed within a flexible frame unit that is removably insertable into a vehicle opening serving to inhibit outside debris and bugs from entering the vehicle while providing ventilation for occupants of said vehicle;
at least one accessory holder comprising a containment means and a levering means to open and close said accessory holder and further comprising key alarm means, temperature gauge accessory, air conditioning accessory, sound alarm accessory, and a hold unit.
wherein said accessory holder is securably attached into said removable ventilation screen creating an accessorizable ventilated window assembly and said accessorizable ventilated window assembly is removably insertable into a vehicle opening.

20. The accessorizable ventilation screen system for use with a vehicle of claim 19, wherein said vehicle opening comprises a window, door, and/or sun-roof.
